(19) United States
(12) Patent Application Publication
(10) Pub. No.: US 2025/0276540 A1
(43) Pub. Date: Sep. 4, 2025

(54) Book with backlit pages

(71) Applicant: Michal Virág, Malá Ida (SK)

(72) Inventor: Michal Virág, Malá Ida (SK)

(21) Appl. No.: 19/026,761

(22) Filed: Jan. 17, 2025

(30) Foreign Application Priority Data
Mar. 4, 2024 (SK) PUV 40-2024

(51) Int. Cl. B42D 3/12

(52) U.S. Cl. CPC B42D 3/123

(57) ABSTRACT

The present application relates to a book with backlit pages. The book with backlit pages includes two shielding light-impermeable films (6) with cut-outs, to which light-permeable print layers (5) containing content graphics (51) are attached, between which a light-conducting fibre (4) is arranged, or the book with backlit pages includes a frame (1) having an internal shaped cut-out (2) with a frame opening (3) formed on the side thereof, in which a light-conducting fibre (4) is arranged which is attached to the internal portion of the frame, one back side of a light-permeable print layer (5) containing content graphics (51) is attached to the front face of the frame (1).

### CROSS-REFERENCE TO RELATED APPLICATION

The present application claims priority to Slovakian patent application No. PUV 40-2024, filed on Mar. 4, 2024 and entitled “Book with Backlit Pages”. Content of the above application is incorporated by reference herein in its entirety.

### TECHNICAL FIELD

The invention relates to books with backlit pages, children's picture books in particular.

### BACKGROUND

Currently, there are number of books on the book market utilizing LED technology for various lighting effects. With these solutions, LEDs are directly inserted into the page of a book at a specific location within the illustration, where they create a spotlight effect. Similarly, optical fibres with end-beam are also utilized, where the emitting end of the fibre is used instead of the LEDs themselves. The disadvantage of these solutions is that they do not allow illuminating more complex planar objects within the illustration, and it is not possible to illuminate blocks of text in such a way that they can be comfortably read even in the dark. The use of LEDs or optical fibres with end-beam emission is also technologically demanding, as the LEDs or the ends of the optical fibres must be placed and anchored in a precisely defined spot on each individual page of the book.

A known technical solution is disclosed in the registered Slovak Utility Model UVz No. 4 870 called Light panel with a perimeter frame structure with LEDs, wherein the LEDs are arranged on the inner side of the perimeter frame structure with light emission of at least one illumination plane which is parallel to the plane of the transparent covering. The disadvantage of this technical solution is that it cannot be used to backlight the pages of books.

Another well-known invention is described in English Patent GB No. 2503 982 entitled Optic fibre greeting card, which includes a three-panel pocket with an internal cavity which contains a fibre optic bundle, various electronic components, fabric layer and a removable panel, wherein a front face of the three-panel pocket contains a substantial opening thereon through which the fabric layer is visible and the fibre optic bundle contains various fibre optic strands each of which inserted through the fabric layer and is visible through the front face of the greeting card and a contact switch controls illumination of the fibre optic strands along with the insertion and removal of the removable panel or, alternatively, in an alternate embodiment, the removable panel may be pivotably attached to the pocket, whereby it substantially exits the pocket when rotated around a pivot point. The disadvantage of this invention is that the end of the fibre optic bundle must be placed and anchored in a well-defined location, and moreover, it cannot be used for backlighting each individual page of the book.

Another known invention is disclosed in U.S. Pat. No. 8,960,936 entitled “Backlit storybook for the visually impaired”, which comprises an audio and visual storybook including a book, a base, and an integral backlight, wherein each page of the book comprises images or words and the book itself is placed upon the base to enable each individual page to backlight the images and words to provide a high-contrast lighted character pattern easily readable by those with impaired vision, wherein the system further includes a speaker for audio to play a corresponding narration and indicates when different pages should be turned. The disadvantage of this invention is that it does not use optical fibre or LED technology and cannot be used to backlight the pages of books.

Another known invention is disclosed in U.S. Patent No. 200 600 769 entitled “Decorative application with a light-conducting assembly made of optical fibres”, comprising an article to be decorated, a light-conducting plate connected to the article and at least one optical fibre connected to a light-emitting module which protrudes the article, the optical fibre having a light source outlet, which is extended from an opening provided on the article in the direction of the light-conducting plate mounted in the opening, and the light-emitting module is controlled by at least one optical fibre connected to the light source outlet from which light is projected towards the light-conducting plate to produce decorative light effect. The disadvantage of this invention is that it does not use LED technology and cannot be used to backlight the pages of books.

Another known invention is disclosed in U.S. Patent No. 20 060 066 094 entitled “Display book with viewing compartment and self-illumination”, wherein the display book system comprises a frame which defines a viewing window, which defines a viewing compartment in a position aligned with the window of the frame, for accommodating a subject to be displayed and which is visible through the viewing window of the frame, wherein a book portion can be annexed thereto to form the display book system which is modified to provide a viewing compartment formed in association with the framed picture portion to allow display of discrete objects including three dimensional objects such as figurines as well as pictures, two dimensional opaque or translucent pictures, wherein illumination capability is provided to allow lighting of the object displayed (front or back-lit), self-illumination or the frame itself can also be illuminated for decorative motivation. The disadvantage of this invention is that it does not use optical fibres or LED technology and cannot be used to backlight the pages of books.

### SUMMARY

The above shortcomings are largely eliminated by the book with backlit pages of the presented invention, the essence of which is that it comprises at least two shielding light-impermeable films with cut-outs, to which light-permeable print layers containing content graphics are attached, between which a light-conducting fibre is arranged, or it comprises a frame having an internal shaped cut-out with a frame opening formed on the side thereof, in which a light-conducting fibre is arranged which is attached to the internal portion of the frame, wherein one back side of a light-permeable print layer containing content graphics is attached to the front face of the frame.

It is preferred that at least one shielding light-impermeable film with cut-outs is attached between the frame and the light-permeable print layer containing the content graphics.

It is further preferred that at least one light-permeable print layer containing the content graphics is attached to one light-permeable print layer containing the content graphics.

It is further preferred that the light-conducing fibre is a side-emitting optical fibre or a LED light chain.

### BRIEF DESCRIPTION OF THE DRAWINGS

The invention will be explained in more detail by means of the drawings, where:

FIG. 1 shows a frame with a rectangular-shaped cut-out and a side-emitting optical fibre and one light-permeable print layer,

FIG. 2 shows a frame with a tree-shaped cut-out and a side-emitting optical fibre and one light-permeable print layer,

FIG. 3 shows a frame with a rectangular-shaped cut-out and a side-emitting optical fibre and five light-permeable print layer,

FIG. 4 shows a frame with a rectangular-shaped cut-out and a side-emitting optical fibre, one light-impermeable film and one light-permeable print layer,

FIG. 5 shows a side-emitting optical fibre, two light-impermeable films and two light-permeable print layers without a frame,

FIG. 6 shows a frame with a rectangular-shaped cut-out, a LED light chain and one light-permeable print layer,

FIG. 7 shows a frame with a tree-shaped cut-out, a LED light chain and one light-permeable print layer,

FIG. 8 shows a frame with a rectangular-shaped cut-out, a LED light chain and five light-permeable print layers,

FIG. 9 shows a frame with a rectangular-shaped cut-out, a LED light chain, one light-impermeable film and one light-permeable print layer,

FIG. 10 shows a LED light chain, two light-impermeable films and two light-permeable print layers without a frame.

### DETAILED DESCRIPTION

### Example 1

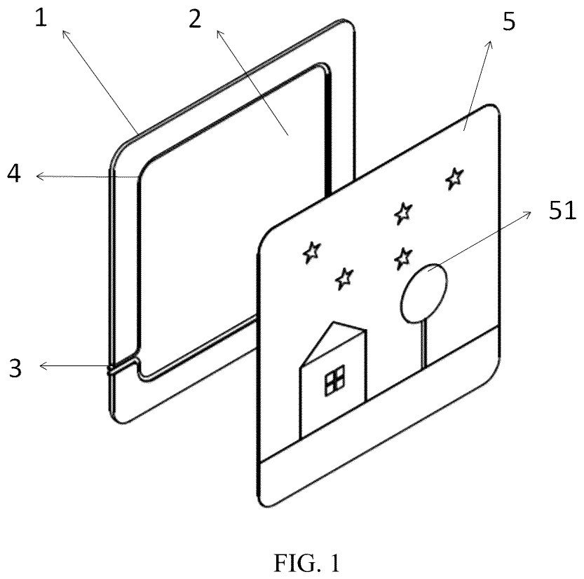

The book with backlit pages of FIG. 1 comprises a frame 1 made of cardboard. An internal shaped cut-out 2 having a rectangular shape is formed in the central part of the frame 1. A frame opening 3 is formed on one side of the frame 1. A light-conducting fibre 4, which is a side-emitting optical fibre, is attached to the internal part of the frame 1 and to the frame opening 3. A light-permeable print layer 5 made of translucent material is attached to the front face of the frame 1. The light-permeable print layer 5 contains content graphics 51, which is the text and/or illustration content of a book.

### Example 2

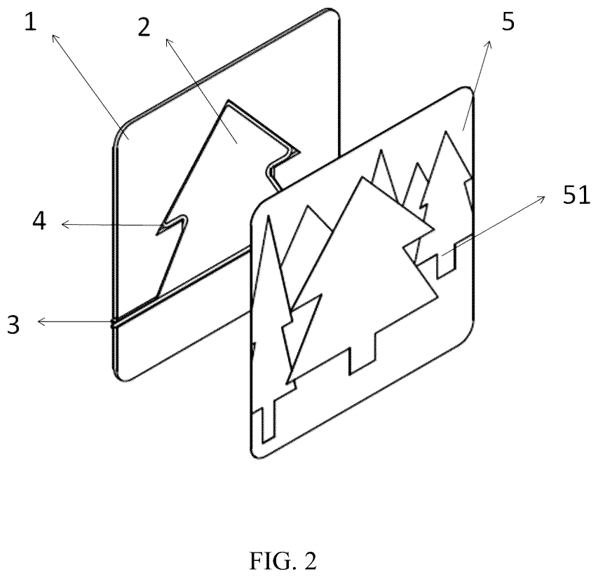

The book with backlit pages of FIG. 2 comprises a frame 1. An internal shaped cut-out 2 having irregular shape of a tree is formed in the central part of the frame 1. A frame opening 3 is formed on one side of the frame 1. A light-conducting fibre 4, which is a side-emitting optical fibre, is attached to the internal part of the frame 1 and to the frame opening 3. A light-permeable print layer 5 made of translucent material is attached to the front face of the frame 1. The light-permeable print layer 5 contains content graphics 51, which is the text and/or illustration content of a book.

### Example 3

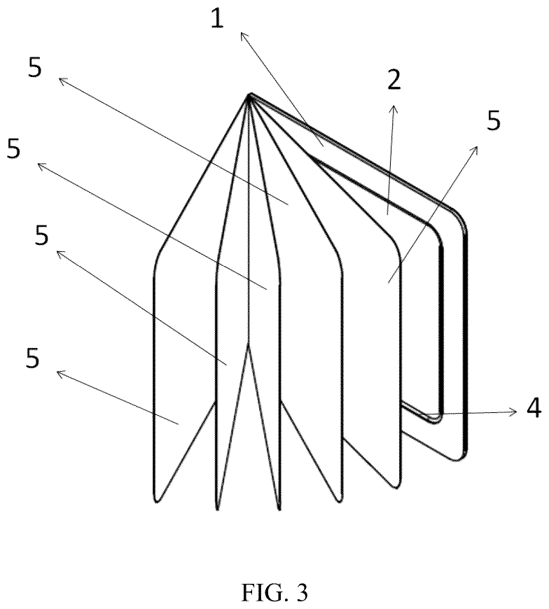

The book with backlit pages of FIG. 3 comprises a frame 1. An internal shaped cut-out 2 having a rectangular shape is formed in the central part of the frame 1. A frame opening 3 is formed on one side of the frame 1. A light-conducting fibre 4, which is a side-emitting optical fibre, is attached to the internal part of the frame 1 and to the frame opening 3. A light-permeable print layer 5 made of translucent material is attached to the front face of the frame 1 of FIG. 3. A second light-permeable print layer 5 is attached to the first light-permeable print layer 5. A third light-permeable print layer 5 is attached to a second light-permeable print layer 5. A fourth light-permeable print layer 5 is attached to the third light-permeable print layer 5. A fifth light-permeable print layer 5 is attached to the fourth light-permeable print layer 5.

### Example 4

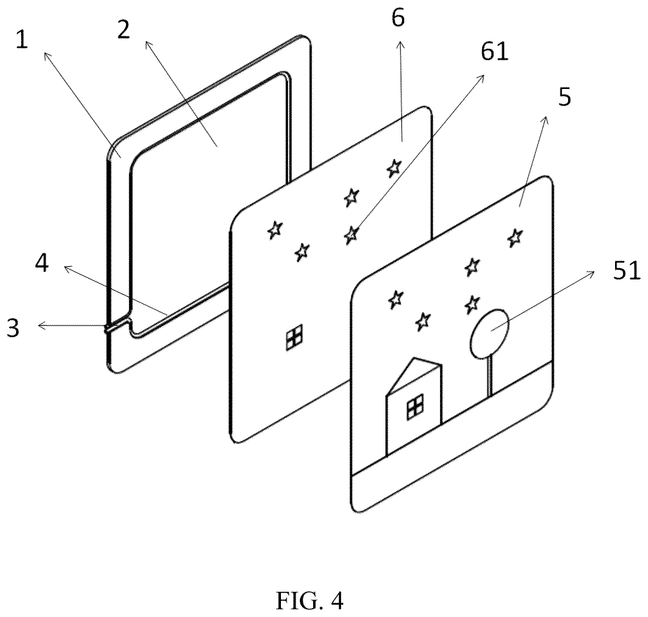

The book with backlit pages of FIG. 4 comprises a frame 1. An internal shaped cut-out 2 having a rectangular shape is formed in the central part of the frame 1. A frame opening 3 is formed on one side of the frame 1. A light-conducting fibre 4, which is a side-emitting optical fibre, is attached to the internal part of the frame 1 and to the frame opening 3. A back side of a shielding light-impermeable film 6 with cut-outs 61 is attached to the front face of the frame 1. A light-permeable print layer 5 made of translucent material is attached to the front face of the shielding light-impermeable film 6 with cut-outs 61. The light-permeable print layer 5 contains content graphics 51, which is the text and/or illustration content of a book.

### Example 5

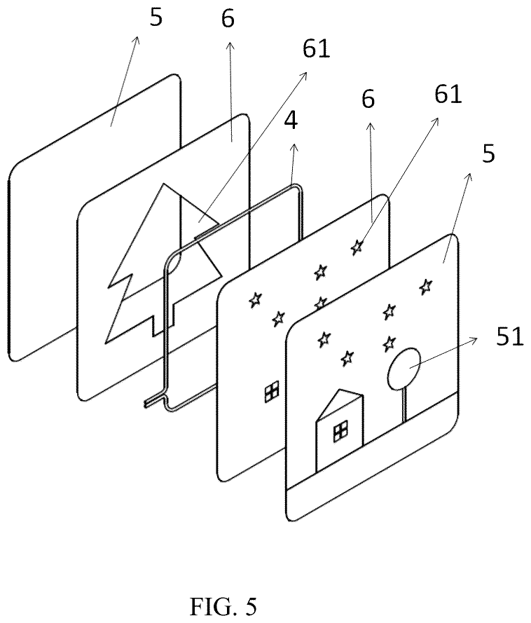

The book with backlit pages of FIG. 5 comprises a light-permeable print layer 5 made of translucent material. A back side of a shielding light-impermeable film 6 with cut-outs 61 is attached to the light-permeable print layer 5. One shielding light-impermeable film 6 with cut-outs 61 is attached to a second shielding light-impermeable film 6 with cut-outs through a light-conducting fibre 4, which is a side-emitting optical fibre. A light-permeable print layer 5 made of translucent material is attached to the front face of the shielding light-impermeable film 6 with cut-outs 61. The light-permeable print layer 5 contains content graphics 51, which is the text and/or illustration content of a book.

### Example 6

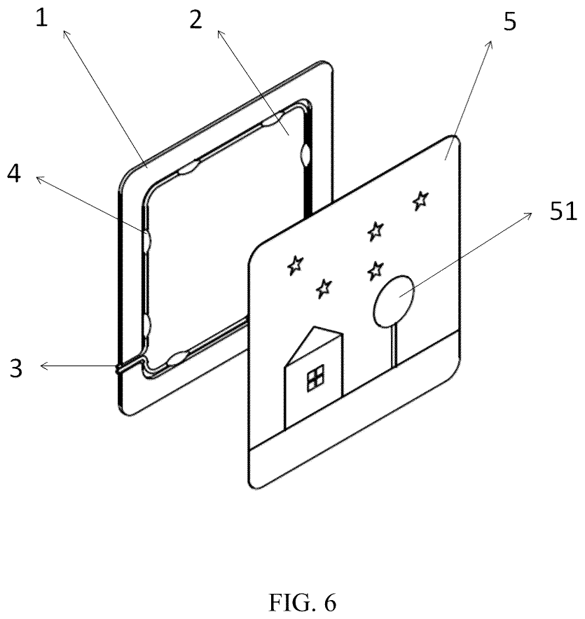

The book with backlit pages of FIG. 6 comprises a frame 1. An internal shaped cut-out 2 having a rectangular shape is formed in the central part of the frame 1. A frame opening 3 is formed on one side of the frame 1. A light-conducting fibre 4, which is a LED light chain, is attached to the internal part of the frame 1. A light-permeable print layer 5 made of translucent material is attached to the front face of the frame 1. The light-permeable print layer 5 contains content graphics 51, which is the text and/or illustration content of a book.

### Example 7

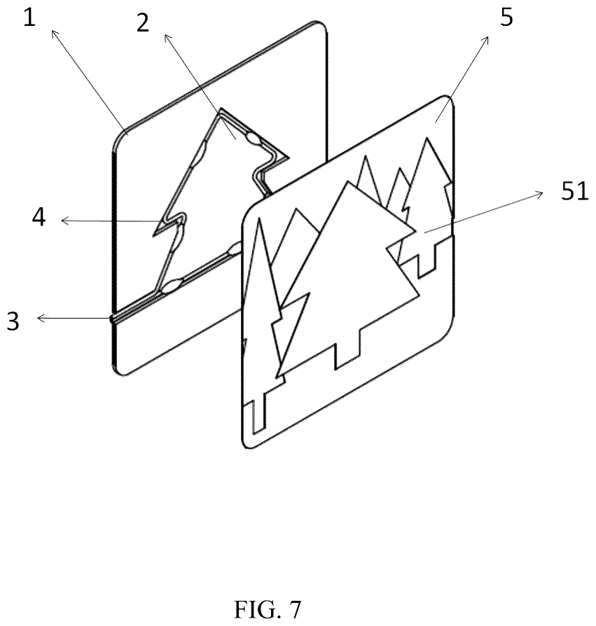

The book with backlit pages of FIG. 7 comprises a frame 1. An internal shaped cut-out 2 having irregular shape of a tree is formed in the central part of the frame 1. A frame opening 3 is formed on one side of the frame 1. A light-conducting fibre 4, which is a LED light chain, is attached to the internal part of the frame 1. A light-permeable print layer 5 made of translucent material is attached to the front face of the frame 1. The light-permeable print layer 5 contains content graphics 51, which is the text and/or illustration content of a book.

### Example 8

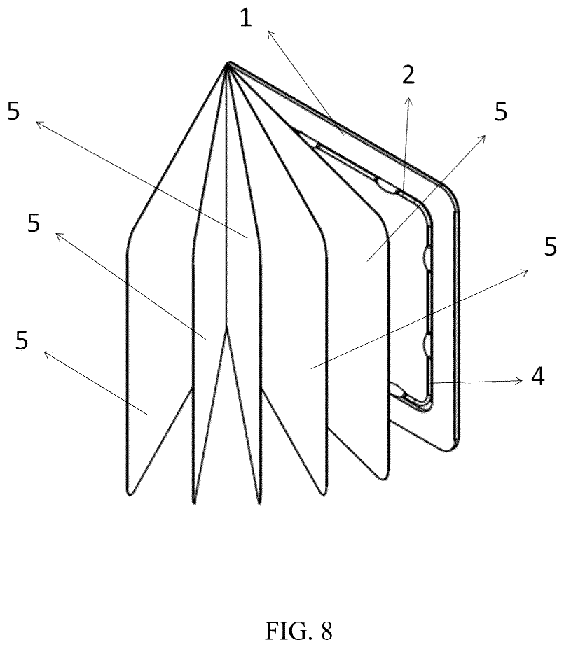

The book with backlit pages of FIG. 8 comprises a frame 1. An internal shaped cut-out 2 having a rectangular shape is formed in the central part of the frame 1. A frame opening 3 is formed on one side of the frame 1. A light-conducting fibre 4, which is a LED light chain, is attached to the internal part of the frame 1. A light-permeable print layer 5 made of translucent material is attached to the front face of the frame 1 of FIG. 8. A second light-permeable print layer 5 is attached to the first light-permeable print layer 5. A third light-permeable print layer 5 is attached to the second light-permeable print layer 5. A fourth light-permeable print layer 5 is attached to the third light-permeable print layer 5. A fifth light-permeable print layer 5 is attached to the fourth light-permeable print layer 5.

### Example 9

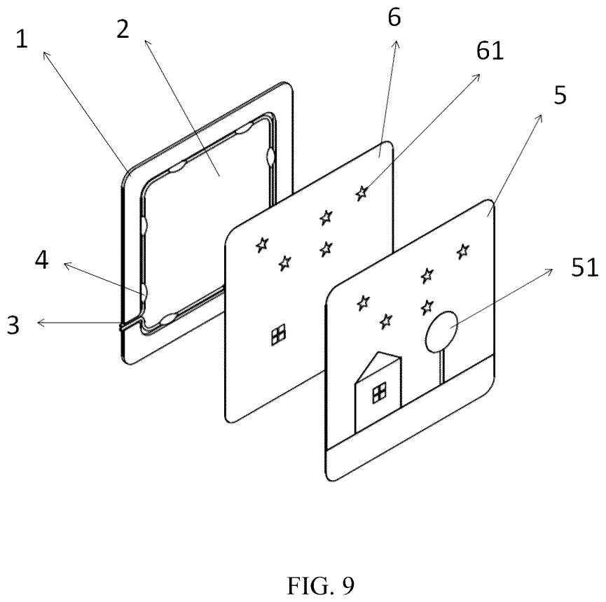

The book with backlit pages of FIG. 9 comprises a frame 1. An internal shaped cut-out 2 having a rectangular shape is formed in the central part of the frame 1. A frame opening 3 is formed on one side of the frame 1. A light-conducting fibre 4, which is a LED light chain, is attached to the internal part of the frame 1. A back side of a shielding light-impermeable film 6 with cut-outs 61 is attached to the front face of the frame 1. A light-permeable print layer 5 made of translucent material is attached to the front face of the shielding light-impermeable film 6 with cut-outs 61. The light-permeable print layer 5 contains content graphics 51, which is the text and/or illustration content of a book.

### Example 10

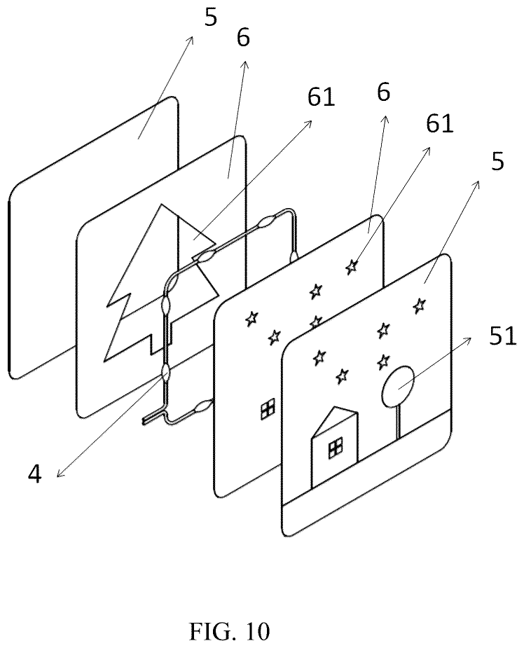

The book with backlit pages of FIG. 10 comprises a light-permeable print layer 5 made of translucent material. A back side of a shielding light-impermeable film 6 with cut-outs 61 is attached to the light-permeable print layer 5. One shielding light-impermeable film 6 with cut-outs 61 is attached to a second shielding light-impermeable film 6 with cut-outs through a light-conducting fibre 4, which is a LED light chain. A light-permeable print layer 5 made of translucent material is attached to the front face of the shielding light-impermeable film 6 with cut-outs 61. The light-permeable print layer 5 contains content graphics 51, which is the text and/or illustration content of a book.

### INDUSTRIAL APPLICABILITY

The presented invention together with an ingenious and complex design can be used not only to make illustrated books more appealing, but also to backlight all the pages of books, thus ensuring the possibility of reading even in the dark without the use of an additional light source. The applicability is made possible by inserting a side-emitting optical fibre or LED light chain into the frame of the book page, making it possible to achieve advanced colour and light effects such as monotone, multi-colour, dimmability, colour changeability and brightness changeability, thus achieving a special lighting effect where only selected areas or selected parts of the illustration glow. Another advantage of the presented invention is that the lighting effect can be achieved even without a shielding layer by an internal cut-out in the frame having a desired shape corresponding to the print layer. The invention can be further used without a frame, wherein a side-emitting optical fibre or LED light chain can be directly inserted between the two shielding layers with glued translucent hooks. The invention can be further used when a single optical fibre frame is covered with several layers of translucent sheets, which must be of a highly translucent material, e.g. a film, and after partial imprinting and overlaying these sheets, it is possible to achieve complex patterns that are changed and unwrapped by flipping through the sheets. The presented invention may use only one method of backlighting using side-emitting optical fibre or LED light chain, or LEDs or the combinations of the given methods. The presented invention can be combined with other available solutions to make books more appealing, in particular by using sound effects, removable parts of pages with puzzle and sliding parts of pages.

### LIST OF REFERENCE SIGNS

1—frame
2—internal shaped cut-out
3—shaped cut-out
4—light-conducting fibre
5—light-permeable print layer
51—content graphics
6—light-impermeable film
61—cut-out

1. A book with backlit pages, wherein it comprises two shielding light-impermeable films (6) with cut-outs, to which light-permeable print layers (5) containing content graphics (51) are attached, between which a light-conducting fibre (4) is arranged, or it comprises a frame (1) having an internal shaped cut-out (2) with a frame opening (3) formed on the side thereof, in which a light-conducting fibre (4) is arranged which is attached to the internal portion of the frame, wherein one back side of a light-permeable print layer (5) containing content graphics (51) is attached to the front face of the frame (1).

2. The book with backlit pages according to claim 1, wherein at least one shielding light-impermeable film (6) with cut-outs (61) is arranged between the frame (1) and the light-permeable print layer (5).

3. The book with backlit pages according to claim 1, wherein at least one light-permeable print layer (5) containing the content graphics (51) is attached to one light-permeable print layer (5) containing the content graphics (51).

4. The book with backlit pages according to claim 1, wherein the light-conducting fibre (4) is a side-emitting optical fibre or a LED light chain.

5. The book with backlit pages according to claim 2, wherein the light-conducting fibre (4) is a side-emitting optical fibre or a LED light chain.

6. The book with backlit pages according to claim 3, wherein the light-conducting fibre (4) is a side-emitting optical fibre or a LED light chain.
